(19) United States
(12) Patent Application Publication
(10) Pub. No.: US 2025/0266651 A1
(43) Pub. Date: Aug. 21, 2025

(54) FEMALE COAXIAL TERMINAL

(71) Applicants: APTIV CONNECTION SYSTEMS (NANTONG) LTD., Nantong (CN); APTIV ELECTRICAL CENTERS (SHANGHAI) CO. LTD., Shanghai (CN)

(72) Inventors: Xiaoxian TIAN, Shanghai (CN); Haifei GUAN, Shanghai (CN)

(21) Appl. No.: 19/055,717

(22) Filed: Feb. 18, 2025

(30) Foreign Application Priority Data
Feb. 18, 2024 (CN) 202410182792.2

(51) Int. Cl. H01R 24/40; H01R 103/00

(52) U.S. Cl. CPC H01R 24/40; H01R 2103/00

(57) ABSTRACT

A female coaxial terminal includes an inner conductor, an insulator sleeved on the outer side of the inner conductor, and an outer conductor. The outer conductor comprises a first body and multiple elastic clamping arms. The first body is sleeved on the outer side of the insulator, spaced apart from it, and features a series of circumferentially arranged windows. Elastic clamping arms are positioned within these windows, extending in a first direction and obliquely towards the insulator. The ends of the clamping arms, opposite the insulator, are connected to the first body. Each clamping arm is equipped with a first protruding structure on the side facing the insulator, providing multi-point protrusions. This configuration enhances the mechanical and electrical connection between the terminal components, ensuring reliable performance in coaxial cable applications.

### CROSS-REFERENCE TO RELATED APPLICATION

This application claims benefit of priority to Chinese Patent Application No. 202410182792.2 filed on Feb. 18, 2024, the entire disclosure of which is hereby incorporated by reference.

### TECHNICAL FIELD OF THE INVENTION

This disclosure relates to the technical field of connector, and in particular, relates to a female coaxial terminal to be used in coaxial connector.

### BACKGROUND

A coaxial terminal is to be terminated onto an end of a coaxial cable, so as to create electrical connection with a mating coaxial terminal. When a female coaxial terminal is mated with a male coaxial terminal, the outer conductor of the female coaxial terminal is sleeved on an outer conductor of the mating male coaxial terminal, so as to maintain the stability of the coaxial connection. Meanwhile, the outer conductors of the two coaxial terminals will provide shielding. However, the contact between female coaxial terminal outer conductor and male coaxial terminal outer conductor is usually to be a line contact, with limited number of contact points, resulting a shieling effect that is not ideal.

Traditional female coaxial terminals have been widely used in various electronic and communication devices to facilitate the transmission of radio frequency signals. These terminals typically consist of an inner conductor, an insulating layer, and an outer conductor. The outer conductor often serves as a shield to prevent electromagnetic interference and to maintain signal integrity. In conventional designs, the outer conductor is usually a solid cylindrical structure that is directly connected to the insulator, providing a straightforward but limited approach to securing the connection between the terminal and the mating male connector.

Previous designs have attempted to improve the mechanical stability and electrical performance of female coaxial terminals by incorporating various clamping mechanisms. Some approaches have included the use of spring-loaded contacts or additional fastening components to enhance the grip on the mating connector. These methods, while effective in increasing the contact pressure and ensuring a stable connection, often result in increased complexity and manufacturing costs. Additionally, the use of separate components for clamping can lead to increased wear and reduced reliability over time.

Another approach has involved the modification of the outer conductor itself to include flexible sections or slits that allow for some degree of elasticity. This design aims to provide a more integrated solution by enabling the outer conductor to flex and adapt to the dimensions of the mating connector. However, these designs often face challenges in achieving consistent contact pressure and may suffer from reduced durability due to the repeated flexing of the material. Furthermore, the lack of precise control over the contact points can lead to suboptimal electrical performance.

However, none of these approaches have provided a comprehensive solution that combines the features described in this disclosure.

### SUMMARY

The purpose of this disclosure is to provide a female coaxial terminal capable providing improved shielding.

According to one aspect of this disclosure, a female coaxial terminal is provided. The female coaxial terminal includes an inner conductor, an insulator sleeved on the outer side of the inner conductor, and an outer conductor including a first body and a plurality of elastic clamping arms. The first body is sleeved on the outer side of the insulator and is spaced apart from the insulator. The first body has a plurality of windows arranged at intervals along the circumference of the first body. The elastic clamping arms are arranged in the windows and extend along a first direction and obliquely towards the insulator. An end of the elastic clamping arm extending away from the insulator is connected to the first body. The elastic clamping arms are provided with first protruding structure on one side facing the insulator. The first protruding structure is to provide multi-point protrusions in order to provide surface contact between the female coaxial terminal and a mating coaxial terminal.

In the above female coaxial terminal, the first body may be provided with the first protruding structure on the side facing the insulator.

In the above female coaxial terminal, the first protruding structures may be a knurled pattern.

In the above female coaxial terminal, the outer conductor may further include multiple second protrusions, the first body may include an open end, and the multiple second protrusions may be arranged at intervals along the circumference of the first body and arranged at the inner peripheral side of the open end.

In the above female coaxial terminal, the outer surface of the second protrusion may be spherical.

In the above female coaxial terminal, the second protrusion may be spaced apart from the elastic clamping arm along the circumference of the first body.

The technical benefits of this disclosure include: by providing a first protruding structure on inner surface of elastic clamping arm of outer conductor of female coaxial terminal, the line contact with outer wall of outer conductor of mating terminal will be replaced by a surface contact having larger area, thus increasing the contact area when coaxial connectors are mated, thereby enhancing the shielding performance of coaxial connector.

### BRIEF DESCRIPTION OF THE DRAWINGS

In order to provide a clearer explanation of the technical solution in the embodiments of the present disclosure, a brief introduction will be given to the drawings to be used for depicting the embodiments. It is obvious that the drawings described below are only some embodiments of the present disclosure and other embodiments me be envisioned.

FIG. 1 is a perspective view of a female coaxial terminal according to some embodiments.

FIG. 2 is a cross-sectional view of the female coaxial terminal according to some embodiments.

FIG. 3 is a perspective view of an outer conductor in the female coaxial terminal according to some embodiments.

FIG. 4 is a side view of an outer conductor in the female coaxial terminal according to some embodiments.

FIG. 5 is a cross-sectional view of an outer conductor in the female coaxial terminal according to some embodiments.

FIG. 6 is a side view of an inner conductor in the female coaxial terminal according to some embodiments.

FIG. 7 is a side view of an insulator in the female coaxial terminal according to some embodiments.

FIG. 8 is a front view of an insulator in the female coaxial terminal according to some embodiments.

FIG. 9 is a perspective view of a shell in the female coaxial terminal according to some embodiments.

### DETAILED DESCRIPTION

The following will provide a clear and complete description of the technical solution the present disclosure referencing the accompanying drawings for the embodiments. Obviously, the embodiments being depicted are only some of the embodiments of the present disclosure, not all of them. Based on the embodiments being depicted in this disclosure, all other implementations that would be obtained by those skilled in the art without creative labor are within the scope of protection of this disclosure.

The following will, with reference to the accompanying drawings for the embodiments, provide a clear and complete description of the technical solution the present disclosure. Obviously, the embodiments being depicted are only a part of the embodiments of the present disclosure, not all of them. Based on the embodiments being depicted in this disclosure, all other implementations that would be obtained by those skilled in the art without creative labor are within the scope of protection of this disclosure.

In the description of this disclosure, it should be understood that the terms “center”, “up”, “down”, “front”, “back”, “left”, “right”, “vertical”, “horizontal”, “top”, “bottom”, “inside”, “outside” and other directional or positional relationships indicated are based on the accompanying drawings and are only for the convenience of describing this disclosure and simplifying the description, and do not indicate or imply that the device or component referred to must have such a specific orientation, be constructed and operated in such a specific orientation, and therefore these terms shall not be understood as a limitation of this disclosure.

The terms ““ first” and “second” are only used for descriptive purposes and shall not be understood as indicating or implying relative importance or implying the number of technical features indicated. Thus, a feature being defined by “first” and “second” may explicitly or implicitly include one or more additional such features. In the description of this disclosure, unless otherwise specified, the meaning of “multiple” refers to two or more.

In the description of this disclosure, “vertical” intends to refer to both completely vertical at 90° and almost completely vertical, for example, an angle within the range of 80° to 100° is considered vertical. Similarly, “parallel” intends to refer to completely parallel or almost completely parallel, for example, an angle within 10° of completely parallel is considered parallel.

When it is intended to transmit RF signal, mated coaxial connectors are usually used. When coaxial connectors are mutually mated, there is a clearance fit between outer wall of male coaxial terminal outer conductor and inner wall of female coaxial terminal outer conductor, and elastic clamping arms are used for securing purpose. The elastic clamping arm is in line contact with the outer wall of the male end outer conductor, especially when the mating of the male coaxial terminal and the female coaxial terminal has an angular deviation. This can lead to poor contact between some elastic clamping arms and the outer wall of the male coaxial terminal outer conductor. However, when this happens, the outer wall of the male coaxial terminal outer conductor is still in line contact with the elastic clamping arm, which can result in even worse shielding effect of the outer conductors.

This disclosure is to propose a female coaxial terminal (also referred to as “female coaxial terminal assembly”) to solve the above problem.

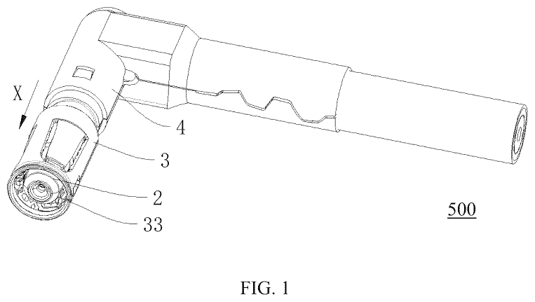

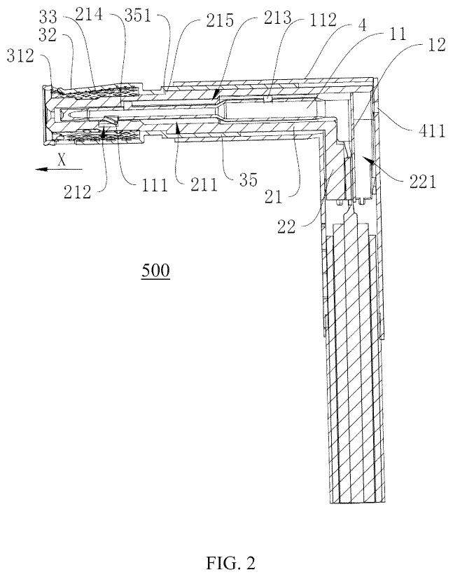

As shown in FIGS. 1-2, an embodiment of the present disclosure provides a female coaxial terminal 500, including an inner conductor 1, an insulator 2, and an outer conductor 3. The insulator 2 is sleeved on the outside of the inner conductor 1. The outer conductor 3 includes a first body 31 and a plurality of elastic clamping arms 32. The first body 31 is sleeved on the outside of the insulator 2 and is spaced apart from the insulator 2, the first body 31 has a plurality of opening windows 311, and the plurality of opening windows 311 are arranged at intervals along the circumference of the first body 31. The elastic clamping arm 32 is arranged in the window 311 and extends along the first direction X and obliquely toward the insulator 2. The elastic clamping arm 32 may be of a cantilever, and an end of the elastic clamping arm 32 away from the insulator 2 is connected to the first body 31, and a first protruding structure 33 is provided on the side of the elastic clamping arm 32 facing the insulator 2.

In the context of this disclosure, the coaxial terminal as shown in FIG. 1 is referred to as female coaxial terminal, and a coaxial terminal to be mated with the coaxial terminal as shown in FIG. 1 is referred to as male coaxial terminal. This is because of the fact that when two coaxial terminals are inserted together, the outer conductor of the female coaxial terminal 500 is to contain the outer conductor of the male coaxial terminal.

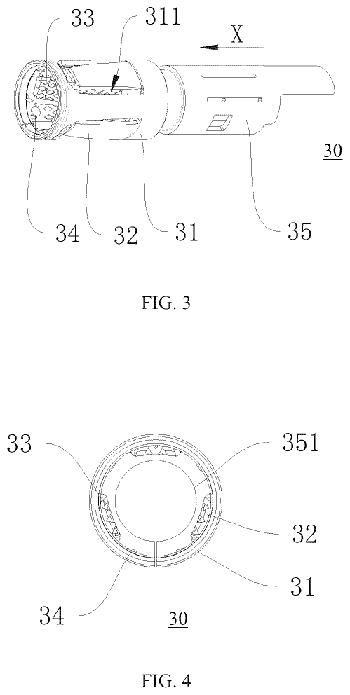

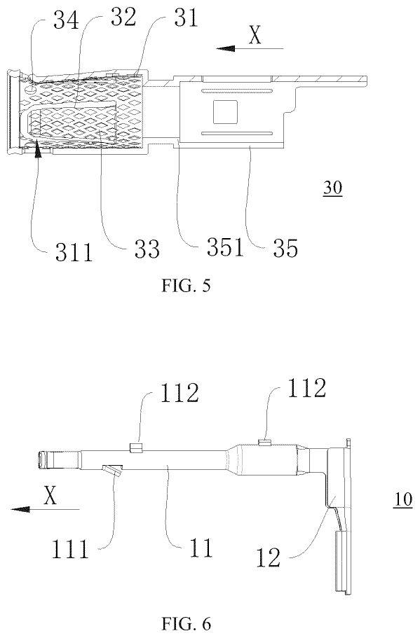

In some embodiments of the present disclosure, as shown in FIGS. 3-5, by covering the surface of the elastic clamping arm 32 of the outer conductor 3 with a first protruding structure 33, the contact between the elastic clamping arm 32 and outer wall of the mating male coaxial terminal outer conductor is changed from line contact to be a surface contact having larger area, which can effectively increase the contact area when coaxial connectors are mated, thereby effectively improving the shielding performance of the coaxial connector.

Specifically, in the embodiments of the present disclosure, the outer conductor 3 of the female coaxial terminal 500 is used to be sleeved on the outer side of the outer conductor of a mating male coaxial terminal, so as to achieve shielding effect. The embodiment of the present disclosure further includes a first protruding structure 33 provided on the side of the elastic clamping arm 32 facing the insulator 2, so as to implement multi-point protrusion on the inner surface of the elastic clamping arm 32, effectively increase the contact area between the elastic clamping arm 32 and the outer wall of an outer conductor of a mating terminal, and further improve the shielding performance, ensuring that the shielded signal has good stability.

It should be noted that the present embodiment of the disclosure can achieve a surrounding wrapping and clamping of a mating terminal through elastic clamping arms 32 arranged at intervals along the circumference of the first body 31. Clamping fixation is achieved through the contact between the elastic clamping arm 32 and the outer wall of the outer conductor of mated terminal. At the same time, the elastic clamping arm 32 contacts the outer wall of the outer conductor of the mated coaxial terminal to achieve signal shielding.

It should be pointed out that, the clamping end of the elastic clamping arm 32 is usually located at the opening of the female end coaxial terminal, and in order to maintain its clamping performance, the clamping end will be inclined and retracted towards the insulator 2. As a result, the diameter of the inscribed circle of the clamping ends of multiple elastic clamping arms 32 may be smaller than the inner diameter of the first body 31. Moreover, in order to facilitate the smooth mating between the mated terminal and the female end coaxial terminal 1, the clamping end of the elastic clamping arm 32 can have a curved edge facing the insulator 2. Therefore, when the first protruding structure 33 is absent, the elastic clamping arm 32 is usually in line contact with the outer wall of the outer conductor of mating terminal, and there may be a situation where the shielding effect is not ideal when the female coaxial terminal is connected with mating terminal. The present disclosure, however, provides a first protruding structure 33 on the inner wall of the elastic clamping arm 32 (the wall facing the side of the insulator 2), which can effectively increase the contact area between the elastic clamping arm 32 and the outer wall of outer conductor of mating coaxial terminal, thereby improving the shielding performance.

In some preferred embodiments, the first protruding structure 33 can be designed to be knurled pattern. In this way, protruding at multiple points is provided, and when the elastic clamping arm 32 is supported and deformed, the contact area is increased, so as to enhance the shielding performance.

Furthermore, in some embodiments of the disclosure, the first protruding structure 33 is not only arranged on the elastic clamping arm 32 at its side facing the insulator 2, but also on the first body 31 at its side facing the insulator 2. In this way, when the female coaxial terminal 500 is connected with a mating male coaxial terminal, the possibility of contact between the first body 31 and the outer wall of the outer conductor of the mating coaxial terminal can be increased, thereby increasing the contact area and further improving the shielding effect.

In some embodiments, as shown in FIGS. 3-4, the outer conductor 3 may further include multiple second protrusions 34. The first body 31 includes an open end 312, and multiple second protrusions 34 are arranged at intervals along the circumference of the first body 31 and arranged at the inner peripheral side of the open end 312.

In some embodiments of the disclosure, multiple second protrusions 34 arranged at intervals along the circumference of the first body 31 define an inscribed circle, and the diameter of the inscribed circle is slightly smaller than the diameter of the outer wall of the outer conductor of a mating terminal, thereby achieving interference fit when the first body 31 is connected with the mating terminal, and ensuring stability. Meanwhile, it further increases the contact area and enhances the shielding effect. Furthermore, the center of the inscribed circle of the multiple second protrusions 34 is located on the central axis of the outer conductor 3. In this way, multiple second protrusions 34 are used to locate and guide the mating terminal upon at the entrance end of the female coaxial terminal, maintaining the accuracy of the angle and avoiding tilting when the female coaxial terminal and a mated terminal are mated.

In some embodiments, the outer surface of the second protrusion 34 is spherical, achieving a smooth transition between the second protrusion 34 and the inner surface of the first body, and thereby the mating terminal can be entered into a location between the insulator 2 and the first body 31 of the female coaxial terminal.

In some embodiments of the disclosure, the second protrusions 34 are arranged at intervals with the elastic clamping arms along the circumference of the first body 31, so as to ensure that the functions of the second protrusions 34 and the elastic clamping arms 32 do not interfere with each other, enabling the second protruding protrusions 34 to achieve its intended positioning function, while enabling the elastic clamping arms 32 to achieve its intended clamping and shielding functions.

In some embodiments, in the initial state, the diameter of the inscribed circle defined by multiple second protrusions 34 needs to be larger than the diameter of the inscribed circle defined by multiple elastic clamping arms 32, such that when the elastic clamping arms 32 are stretched and expanded, the elastic clamping arms 32 can contact the outer wall of outer wall of mating terminal and simultaneously contact the second protrusion 34.

In some embodiments, as shown in FIG. 6, the inner conductor 1 of the female coaxial terminal 500 includes an inner conductor front section 11 and an inner conductor rear section 12. The inner conductor front section 11 extends along the first direction X, and the inner conductor rear section 12 is bent relative to the inner conductor front section 11. The inner conductor front section 11 and the inner conductor rear section 12 are integral as a one part.

In some embodiment of the disclosure, the female coaxial terminal 500 may be a bent terminal, that is, the insertion portion can have an angle with respect to the wiring portion. Specifically, the female coaxial terminal 500 can be a 90-degree bent coaxial terminal, and accordingly, the inner conductor 1 and insulator 2 are also 90 degree bent structures. In some embodiment of the disclosure, the inner conductor 1 is an integrated part. This integral one-piece inner conductor 1 can ensure connection stability, reduce the risk of vibration impact failure, and thus ensure the stability of signal transmission.

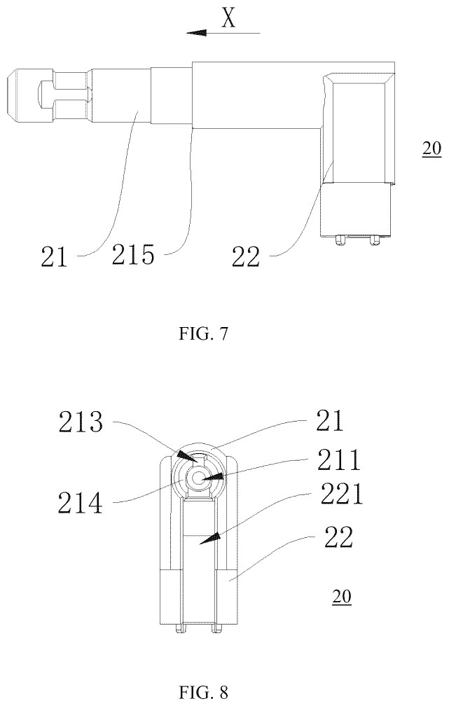

Furthermore, in some embodiments, as shown in FIGS. 7-8, the insulator 2 of the female coaxial terminal includes an insulator front section 21 and an insulator rear section 22. The insulator front section 21 extends along the first direction X, and the insulator rear section 22 is bent relative to the insulator front section 21. The insulator front section 21 and the insulator rear section 22 are integral as one part. The insulator front section 21 is sleeved outside the inner conductor front section 11, and the inner conductor insulator rear section 22 is sleeved outside the rear section 12.

Furthermore, in some embodiments, as shown in FIG. 8, the insulator front section 21 has a receiving cavity 211 that runs through the insulator front section 21 along the first direction X, and the insulator rear section 22 has a receiving groove 221 that extends along the second direction. The receiving groove 221 is in communication with the receiving cavity 211, and the notch of the receiving groove 221 faces in the opposite direction of the first direction X, so that the inner conductor front section 11 is to be inserted into the receiving cavity 211 along the first direction X, and the inner conductor rear section 12 is to be inserted into the receiving groove 221.

In particular, the front section 11 of the inner conductor is directly inserted into the receiving cavity 211 along the first direction X from the end connected to the insulator front section 21 and the insulator rear section 22. After the inner conductor front section 11 is completely inserted into the receiving cavity 211, the inner conductor rear section 12 smoothly enters the receiving groove 221. At this point, the assembly of the inner conductor 1 and the insulator 2 can be directly completed, and the operation is simple and convenient. Therefore, the arrangement of this structure in the present disclosure allows the bent inner conductor 1 to be directly inserted into the receiving cavity 211 and the receiving groove 221 of the insulator 2, ensuring one-stop assembling effectively reducing assembly difficulty, improving assembly efficiency, and maintaining the insulation performance of the insulator 2.

In some embodiments, as shown in FIG. 2, the inner wall of the insulator front section 21 is provided with a limiting slot 212. As shown in FIG. 6, the outer wall of the inner conductor front section 11 is provided with an elastic limiting part 111. The elastic limiting part 111 is set in the limiting slot 212 to limit the front section 11 of the inner conductor in a direction opposite to the first direction X, preventing the front section 11 of the inner conductor from coming out of the insulator front section 21 in the direction opposite to the first direction X and then coming out.

In some embodiment of the disclosure, the elastic limiting part 111 extends obliquely away from the inner conductor front section 11, and along a direction opposite to the first direction X. When the inner conductor front section 11 penetrates the receiving cavity 211, the elastic limiting part 111 compresses and deforms the inner conductor front section 11, achieving smooth penetration of the inner conductor front section 11. When the elastic limiting part 111 reaches the limiting slot 212, the space becomes larger, and the elastic limiting part 111 is released, extending into the limiting slot 212. The groove wall of the limiting slot 212 is used to limit and contact the elastic limiting part 111, preventing it from retracting and achieving effective limiting.

In some embodiments, as shown in FIG. 2, the inner wall of the insulator front section 21 is also provided with a guiding slot 213. As shown in FIG. 7, the outer wall of the inner conductor front section 11 is provided with a guiding part 112, which is slidably arranged in the guiding slot 213.

In some embodiment of the disclosure, the cooperation of the guiding slot 213 and the guiding part 112 is to provide guidance for the insulator front section 21 to penetrate the receiving cavity 211, so as to ensure that the elastic limiting part 111 can smoothly enter the limiting slot 212, and to achieve smooth assembly of the inner conductor 1 and the insulator 2.

In some embodiments, as shown in FIG. 2 and FIG. 8, the inner wall of the insulator front section 21 is also provided with a blocking portion 214, which is set at one end of the guiding slot 213 away from the inner conductor rear section 12. The guiding part 112 is in contact with the blocking portion 214 to limit the inner conductor front section 11 along the first direction X, so as to prevent the inner conductor front section 11 from overly entering into the receiving cavity 211.

In some embodiments, multiple guiding parts 112 are provided on the outer wall of the inner conductor front section 11, and the multiple guiding parts 112 are arranged at intervals along the first direction X. The multiple guiding parts 112 are provided to increase the outer diameter of the inner conductor front section 11. By using the guiding parts 112 to offset against the groove bottom of the guiding slot 213, the stability of the position of the inner conductor front section 11 in the receiving cavity 211 can be achieved, avoiding the movement of the inner conductor front section 11 in the receiving cavity 211 due to an overly large gap between the inner conductor front section 11 and the cavity wall of the receiving cavity 211, thereby achieving good anti-vibration effect and maintaining the stability of the coaxial terminal.

In some embodiments, as shown in FIGS. 3-5, the outer conductor 3 includes a second body 35, which is integrally connected to the first body 31 and sleeved on the outer side of the insulator front section 21. The inner wall of the second body 35 is provided with a step 351, and the outer wall of the insulator front section 21 is provided with a limiting protrusion 215. The limiting protrusion 215 cooperates with the step 351 to limit the insulator front section 21 along the first direction X.

In some embodiment of the disclosure, a post-assembling mutual positioning between the second body 35 and the insulator front section 21 is achieved by utilizing the mutual cooperation between the limiting protrusion 215 and the step 351, ensuring the stability of the assembly between the outer conductor 3 and the insulator 2, and avoiding the displacement of the outer conductor 3 along the first direction X.

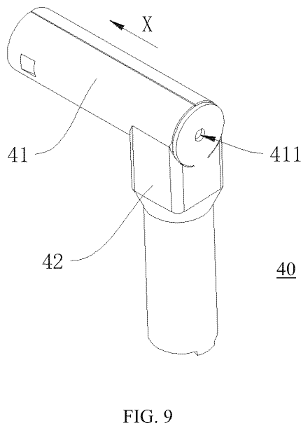

In some embodiments, as shown in FIG. 9, the female coaxial terminal further includes a shell 4, which includes a front housing 41 and a rear housing 42 which are integrally connected to form one part. The front housing 41 extends along the first direction X, and the rear housing 42 is bent relative to the front housing 41. The front housing 41 is sleeved on outer side of a part of the outer conductor 3 and a part of the insulator front section 21, and the rear housing 42 is sleeved on the outer side of the insulator rear section 22.

In some embodiment of the disclosure, the outer shell 4 is used to wrap around the outer conductor 3, the insulator 2, and the inner conductor 1 exposed from the receiving groove 221 of the insulator 2, achieving structural stability and protecting the inner conductor 1.

In some embodiments, the end of the front housing 41 away from the outer conductor 3 is provided with a detection hole 411, which is opposite to the inner conductor 1 and is to detect the vertical distance between the inner conductor 1 and the detection hole 411.

In some embodiment of the disclosure, the inner conductor 1 and the insulator 2 are to be directly assembled, and then the outer conductor 3 and the shell 4 are to be assembled. To avoid the occurrence of failure of the female coaxial terminal due to displacement of the inner conductor 1, a detection hole 411 is set on the shell 4. An external detection equipment can be used to directly detect the vertical distance between the inner conductor 1 and the detection hole 411 through the detection hole 411, and the distance can be used to determine whether the inner conductor 1 is assembled in place, thereby determining whether the inner conductor 1 of the female coaxial terminal 500 is assembled properly. In the above embodiments, the description of each embodiment has its own emphasis. For the parts that are not detailed in one embodiment, please refer to the relevant descriptions of other embodiments.

The above embodiments are only used to help understand the technical solution and core idea of the present disclosure; Ordinary technical personnel in this field should understand that they can still modify the technical solutions described in the aforementioned embodiments, or equivalently replace some of the technical features; And these modifications or substitutions do not deviate from the essence of the corresponding technical solutions from the scope of the technical solutions of the various embodiments of the present disclosure.

### REFERENCE SIGNS

1. Inner Conductor
2. Insulator
3. Outer Conductor
4. Shell
11: Inner conductor Front Segment
111 Elastic Limiting Part
112: Guiding Part
12: Inner conductor Rear Segment
21: Insulator Front Section
211: Receiving Cavity
212: Limiting Slot:
213: Guiding Slot
214: Blocking Portion
215: Limiting Protrusion
22: Insulator Rear Section
221: Receiving Slot
31: First Body
311: Opening Window
312: Open End
32: Elastic Clamping Arm
33: First Protruding Structure
34: Second Protrusion
35: Second Body
351: Step
41: Horizontal Shell
411: Detection Hole
42: Vertical Shell
500: Female Coaxial Terminal

1. A female coaxial terminal, comprising:
an inner conductor;
an insulator sleeved on an outer side of the inner conductor; and
an outer conductor comprising a first body and a plurality of elastic clamping arms, wherein the first body is to be sleeved on outer side of the insulator, the first body is sleeved on the outer side of the insulator and being spaced apart from the insulator, the first body has a plurality of windows arranged at intervals along a circumference of the first body, the elastic clamping arms are arranged in the windows and extend along a first direction and obliquely towards the insulator, and an end of the elastic clamping arm away from the insulator is connected to the first body, the elastic clamping arms are provided with first protruding structure on one side facing the insulator, and the first protruding structure provides multi-point protrusions.

2. The female coaxial terminal according to claim 1, wherein the first body is provided with the first protruding structure on the side facing the insulator.

3. The female coaxial terminal according to claim 1, wherein the first protruding structures is knurled pattern.

4. The female coaxial terminal according to claim 1, wherein the outer conductor further comprises multiple second protrusions, the first body comprises an open end, and the multiple second protrusions are arranged at intervals along the circumference of the first body and arranged at an inner peripheral side of the open end.

5. The female coaxial terminal according to claim 4, wherein an outer surface of the second protrusion is spherical.

6. The female coaxial terminal according to claim 4, wherein the second protrusion is spaced apart from the elastic clamping arm along the circumference of the first body.

7. The female coaxial terminal according to claim 1, wherein the inner conductor comprises an inner conductor front section and an inner conductor rear section, the inner conductor front section extends along the first direction, the inner conductor rear section is bent relative to the inner conductor front section, and the inner conductor front section and the inner conductor rear section are integrally connected.

8. The female coaxial terminal according to claim 7, wherein the insulator comprises an insulator front section and an insulator rear section, the insulator front section extends along the first direction, the insulator rear section is bent relative to the insulator front section, and the insulator front section and an insulator rear end are integrally connected and wherein the insulator front section insulator is sleeved outside the inner conductor front section, and the insulator rear section is sleeved outside the inner conductor rear section.

9. The female coaxial terminal according to claim 8, wherein the insulator front section has a receiving cavity penetrating through the insulator front section along the first direction, the insulator rear section has a receiving slot extending along a second direction, the receiving slot is in communication with the receiving cavity, and a notch of the receiving slot faces a direction opposite to the first direction, so that along the first direction, the inner conductor front section is to be inserted into the receiving cavity, and the inner conductor rear section is to be inserted into a receiving groove.

10. The female coaxial terminal according to claim 9, wherein an inner wall of the insulator front section is provided with a limiting slot, and an outer wall of the inner conductor front section is provided with an elastic limiting part, which is set in the limiting slot to limit the inner conductor front section in a direction opposite to the first direction.

11. The female coaxial terminal according to claim 10, wherein the inner wall of the insulator front section is further provided with a guiding slot, and the outer wall of the inner conductor front section is provided with a guiding part, which is slidably arranged in the guiding slot.

12. The female coaxial terminal according to claim 11, wherein the inner wall of the insulator front section is further provided with a blocking portion, which is set at one end of the guiding slot away from the inner conductor rear section, and the guiding part is in contact with the blocking portion to limit the inner conductor front section along the first direction.

13. The female coaxial terminal according to claim 12, wherein the guiding parts are arranged at intervals along the first direction on the outer wall of the inner conductor front section.

14. The female coaxial terminal according to claim 8, wherein the outer conductor comprises a second body, which is integrally connected to the first body and sleeved on the outer side of the insulator front section, an inner wall of the second body is provided with a step, and the outer wall of the insulator front section is provided with a limiting protrusion, wherein cooperation between the limiting protrusion and the step is configured to limit the insulator front section along the first direction.

15. The female coaxial terminal according to claim 10, wherein, the female coaxial terminal further comprises a shell which includes a front housing and a rear housing, the front housing extends along the first direction, and the rear housing is bent relative to the front housing, wherein the front housing is sleeved on the outer side of the outer conductor and the insulator front section, and the rear housing is sleeved on the outer side of the insulator rear section, the front housing is provided with a detection hole at one end away from the outer conductor, and the detection hole is opposite to the inner conductor.
